(19) United States
(12) Patent Application Publication
(10) Pub. No.: US 2023/0303448 A1
(43) Pub. Date: Sep. 28, 2023

(54) ZrO2-REINFORCED MULLITEFIBERS, PROCESSES FOR MANUFACTURING SAME, AND USE THEREOF

(71) Applicant: DEUTSCHE INSTITUTE FÜR TEXTIL-UND FASERFORSCHUNG DENKENDORF, Denkendorf (DE)

(72) Inventors: Bernd CLAUSS, Göppingen (DE); Stephanie PFEIFER, Sindelfingen (DE); Leonie REINDERS, Ostfildern (DE); Michael R. BUCHMEISER, Remshalden (DE)

(21) Appl. No.: 18/020,581

(22) PCT Filed: Aug. 10, 2021
(86) PCT No.: PCT/EP2021/072266

§ 371 Date: Feb. 9, 2023

(30) Foreign Application Priority Data
Aug. 12, 2020 (DE) 10 2020 121 221.6

(51) Int. Cl. C04B 35/185; C04B 35/622; C04B 35/64; C04B 35/634; C04B 35/638; D01F 9/08; D01F 1/10

(52) U.S. Cl. CPC C04B 35/185; C04B 35/62245; C04B 35/64; C04B 35/63444; C04B 35/638; D01F 9/08; D01F 1/10; C04B 2235/3463; C04B 2235/3244; C04B 2235/3418; C04B 2235/444; C04B 2235/6567; C04B 2235/95

(57) ABSTRACT

The invention relates to ZrO₂-reinforced mullite fibers having a content of at least 0.1 wt. % of crystalline ZrO₂, said mullite fibers being distinguished by significantly improved mechanical properties compared to unmodified mullite fibers. The invention further relates to processes for manufacturing such fibers, green fibers produced as an intermediate product in the process, and the use of the ZrO₂-reinforced mullite fibers in fibre-matrix composite materials.

The invention relates to ZrO₂-reinforced mullite fibers having a content of at least 0.1 wt. % of crystalline ZrO₂, said mullite fibers being distinguished by significantly improved mechanical properties compared to unmodified mullite fibers. The invention further relates to a process for manufacturing such fibers, green fibers manufactured as an intermediate product in the process, and the use of the ZrO₂-reinforced mullite fibers in fibre-matrix composite materials.

### PRIOR ART

Mullite is a mineral that occurs rarely in nature and is formed under high temperatures and at low pressures. It is the only stable binary compound of the Al₂O₃·SiO₂ system. In technical applications mullite represents one of the most important phases in ceramics on account of its advantageous properties and has a broad application range. These properties include, amongst other things, a high thermal stability (up to temperatures above 1700° C.), a low thermal expansion and thermal conductivity, a low density, and a strength and fracture toughness that are suitable for many applications. Mullite ceramics are additionally distinguished by low creep rates and good corrosion resistance. They are used traditionally for porcelain and stoneware, and also as refractory materials in the steel, cement and chemical industries.

Besides the aforementioned advantages, a key advantage of mullite lies in the fact that the starting materials from which mullite can be obtained are available in large quantities at comparatively low cost, and therefore in recent years mullite has become increasingly important in the field of high-performance ceramics. Applications in which mullites have been used more and more relate, amongst other things, to monolithic ceramics, the typical applications of which lie, amongst other things, in the field of refractory materials and catalyst supports, films and coatings for preventing material degradation in oxidising atmospheres, and mullite fibers, which can be used as such or in ceramic composite materials.

Document EP 2 173 683 A1 describes, amongst other things, the use of mullite fibers to form solid highly porous structures for filtrations, insulation and high-temperature processes, and chemical reactions. DE 10 2008 004 532 A1 relates to mullite fibers with nanoscale grain size of up to 200 nm for use in ceramic composite materials.

Previously commercially available mullite fibers, which additionally also contain a proportion of corundum grains dispersed in the mullite, are obtainable under the trade name Nextel 720®. These fibers have a very high creep resistance and room-temperature tensile strength, but demonstrate a significant drop in Weibull strength at higher temperatures. Pure mullite fibers with a composition close to a stoichiometric 3:2 mullite demonstrate lower absolute Weibull strengths, but a much smaller reduction in Weibull strength at temperatures above 1000° C.

Zirconium dioxide (ZrO₂) is used in the refractory sector and as a functional material. ZrO₂ exists in three structural modifications: a monoclinic modification (m-ZrO₂), which converts at approximately 1170° C. into the tetragonal modification (t-ZrO₂), and a cubic modification (c-ZrO₂), which forms at approximately 2370° C. from the tetragonal modification.

ZrO₂ is distinguished by a low thermal conductivity of 2 W/m·K at 1000° C. (Al₂O₃ has a thermal conductivity of 7 W/m·K at the same temperature). Further advantageous properties of ZrO₂ are the high melting point in the range of 2680-2710° C. and also its very high hardness and wear resistance. ZrO₂ ceramics therefore belong to the oxidic ceramics with the greatest hardness, which hitherto were synthesised.

A problem with the use of ZrO₂ in ceramics often lies in the fact that such ceramics have a very unfavourable fracture behaviour, which is caused by the fact that ZrO₂ demonstrates a volume expansion of 3-5% when transitioning from the tetragonal into the monoclinic modification. This conversion usually occurs at temperatures below approximately 950° C.

In order to counteract these conversion processes, various additives and stabilising agents have been proposed in the literature for the manufacture of mullite ceramics, for example the addition of Y₂O₃ (see S. Prusty et al. Adv. Appl. Ceram. 2013, 110, pages 360-366). In addition, Li et al describe in J. Ceram. Sci Technol. 2016, 7, pages 417-422 a spark plasma sintering process, with which 1-4 wt. % of ZrO₂ were able to be incorporated into mullite ceramics. Such a process would not be suitable, however, for the manufacture of ceramic fibers, since the most homogeneous distribution possible of the ZrO₂ particles in the mullite structure, which inhibits their grain growth, cannot be achieved by the rod-shaped ZrO₂ examined in the studies.

Against the background of the prior art presented above, there is a need for ceramic fibers and in particular for mullite fibers which have an improved strength profile in comparison to the known mullite fibers and which in particular demonstrate a higher Weibull strength compared to pure mullite fibers and at higher temperatures do not demonstrate a significant drop in Weibull strength compared to the described commercial fibers. The present invention addresses this need.

### DESCRIPTION OF THE INVENTION

The present invention is based on the surprising finding that the sought improvement in breaking loads and breaking elongations of mullite fibers can be achieved by the inclusion of ZrO₂ in the fibers, with no deterioration of other properties having been observed. Such fibers can be manufactured by mixing the starting materials required for the fibers, then spinning to produce green fibers, calcining, and sintering the fibers, with crystalline ZrO₂ being obtained at least proportionately.

In accordance with a first aspect, the present invention relates to ZrO₂-reinforced mullite fibers which contain at least 0.1 wt. % of crystalline ZrO₂.

In the invention described here, “mullite” refers to a mineral having the chemical composition Al^{[6]}Al₁₊ₓ^{[4]}[O|Si₁₋ₓO_{4-x/2}], wherein x≈0.2. After the manufacturing process, synthetic mullite of composition 3 Al₂O₃×2 SiO₂ is referred to as sintered mullite, and mullite of composition 2 Al₂O₃×1 SiO₂ is referred to as molten mullite. The term “mullite” as defined here comprises both variants. In relation to the stated ratios, it is clear that no free Al₂O₃ or SiO₂ is present in mullite, however, this ratio is specified here to provide a simplified description of the ratios of Al₂O₃ or SiO₂ in the mullite. These ratios describe molar ratios.

The term “crystalline ZrO₂” specifies that at least a proportion of the ZrO₂ is present in crystalline form in the fibers, although it is not ruled out that non-crystalline or amorphous proportions of ZrO₂ are additionally contained in the mullite fibers. The presence of crystalline ZrO₂ can be demonstrated by means of the reflections, characteristic of this presence, in x-ray diffractograms.

In respect of the content of crystalline ZrO₂, the present invention is not subject to any relevant limitations, and the content of crystalline ZrO₂ should, on the one hand, be of such a level that the reinforcing effect is as favourable as possible. On the other hand, however, the proportion of ZrO₂ should not be so great that it is detrimental to the overall properties of the fibers. Here, a proportion of at least 0.5 wt. %, preferably at least 1 wt. %, and more preferably at least 2 wt. %, even more preferably at least 3.1 wt. %, and even more preferably at least 3.5 wt. % are stated as being preferred for a good realisation of the reinforcing properties. The maximum content of ZrO₂ preferably should not exceed 15 wt. % here, and in a particularly preferred embodiment should not be greater than 10 wt. %. Particularly favourable reinforcing properties are achieved with ZrO₂ contents in the range from approximately 2 to 15 wt. %, in particular from approximately 3 to 10 wt. %, and particularly preferably from approximately 3.5 to 10 wt. % of crystalline ZrO₂, which are thus particularly preferred in the context of the present invention.

It was found within tests forming the basis of the present invention that the ZrO₂ is present in the fibers at least largely as tetragonal ZrO₂ also below the temperature of 950° C., which is relevant for the conversion into monoclinic ZrO₂. Within the scope of the invention it is therefore preferred if the ZrO₂ is contained in the ZrO₂-reinforced mullite fibers in the tetragonal modification.

The grain size of the ZrO₂ in the ZrO₂-reinforced mullite fibers is of a certain importance, since with a high grain size the tetragonal modification of ZrO₂ in unstabilised formed is not sufficiently stable. A range from approximately 10 to 60 nm, in particular from approximately 20 to 35 nm, can be specified here as a particularly suitable span for the crystalline ZrO₂ grain sizes. The grain sizes are determined graphically using microscopic images of thermally etched cross-sectional surfaces by means of line intercept methods according to DIN EN ISO 13383-1:2016-11. On the basis of the determined grain sizes, an advantageously homogeneous distribution of the ZrO₂ in the mullite fibers is clear and favours a higher strength of the fibers. The mean grain size of the ZrO₂ in the ZrO₂-reinforced mullite fibers lies preferably within the above-specified ranges.

In the described mullite fibers, mullite accounts for the greatest proportion of the constituents. It is preferred in this context if the proportion of mullite, in particular of crystalline mullite, in the mullite fibers accounts for at least 80 wt. %, in particular at least 85 wt. %, and particularly preferably 90 to 97.5 wt. %. With such proportions, it is ensured that the overall properties of the obtained fibers are as similar as possible to the corresponding properties of pure mullite fibers.

The ratio of ceramic-forming Al₂O₃ and SiO₂ precursors from which the mullite is formed should be set expediently such that, when processing the precursors to form the fibers, the greatest possible mullite proportion can form in the fibers. It is preferred here if the mullite fibers contain, in relation to the total amount of Al₂O₃ and SiO₂, approximately 71 to 80 wt. %, in particular approximately 73 to 78 wt. %, and particularly preferably approximately 75 to 78 wt. % of theoretical Al₂O₃ proportion in the mullite phase. In the case of this proportion, on account of the reference to the mullite phase, additionally present ZrO₂ or further ceramic constituents are not taken into consideration.

The grain size of the mullite in the ZrO₂-reinforced mullite fibers lies expediently in the range from 50 to 200 nm, in particular from approximately 80 to 150 nm. The grain size of the mullite is to be determined here, analogously to the determination of the grain size of the ZrO₂, graphically using microscopic images of thermally etched cross-sectional surfaces by means of line intercept methods according to DIN EN ISO 13383-1:2016-11. The comparatively small grain size of the mullite causes the high strength found for the ZrO₂-reinforced mullite fibers according to the invention, this strength being compromised by larger mullite grains. The mean grain size of the mullite in the ZrO₂-reinforced mullite fibers lies preferably within the above-specified ranges.

Besides mullite and ZrO₂, the ZrO₂-reinforced mullite fibers according to the invention can contain further inorganic constituents and residual phases, in particular in the form of crystalline Al₂O₃, which can form from an excess of ceramic-forming Al₂O₃ precursor during the manufacture of the fibers. In one embodiment, such a residual phase and in particular a residual phase formed of corundum, is preferred in accordance with the invention since the mechanical properties of the mullite fibers can thus be further improved.

Further materials which, additionally to mullite and crystalline ZrO₂, can be contained in the mullite fibers according to the invention are, for example, Y₂O₃, Yb₂O₃, HfO₂, CeO₂, and also other transition metal oxides or oxides of the lanthanides.

The ZrO₂-reinforced mullite fibers according to the invention are preferably present in the form of filaments which are also referred to as endless filaments or endless fibers (i.e. fibers of practically unlimited length, used here synonymously). The fibers additionally have a diameter of preferably >5 μm so as to be able to provide a desirable stability. A fibre diameter in the range from 7 to 13 μm is very particularly preferred.

The ZrO₂-reinforced mullite fibers according to the invention are distinguished by an improved breaking load and maximum elongation in the flexural test compared to known mullite fibers. Consequently, the ZrO₂-reinforced mullite fibers according to the invention preferably have a breaking load of at least 12.0 N, in particular of at least 14.0 N, and particularly preferably of at least 15.0 N, determined on a fibre bundle of 468 filaments with a thickness of approximately 10 μm at a testing speed of 5 mm/min at a fixed deflection with a diameter of 2.5 mm. Additionally or alternatively, the fibers have values for the breaking elongation of at least 1.5%, in particular of at least 1.6%, and particularly preferably of 2.0%. For further details regarding the determination of the breaking load and breaking elongation, reference is made to the information in the example part.

As explained above, the ZrO₂-reinforced mullite fibers according to the invention can be manufactured by mixing the starting materials required for the fibers, subsequent spinning to produce green fibers, calcining, and sintering the fibers. Consequently, a further aspect of the invention described here relates to a process for manufacturing ZrO₂-reinforced mullite fibers comprising the following steps:
(i) producing a spinning solution from a ceramic-forming SiO₂ precursor, a ceramic-forming Al₂O₃ precursor, a water-soluble organic polymer, a ceramic-forming ZrO₂ precursor and optionally a stabiliser, wherein with use of a stabiliser this is used preferably as solution with the ceramic-forming ZrO₂ precursor,
(ii) if necessary, partially evaporating water of the spinning solution in order to produce a spinning mass with a zero-shear-rate viscosity of at least 150 Pas, in particular in the range of 180 to 350 Pas (determined in each case at 25° C.),
(iii) dry spinning the spinning mass, thus obtaining green fibers,
(iv) calcining the green fibers, thus forming inorganic precursor fibers, wherein volatile constituents are removed pyrolytically, and
(v) sintering the inorganic precursor fibers, with mullite-phase formation, to give ZrO₂-reinforced mullite fibers.

In the first step (i), a spinning solution is consequently produced which contains all constituents of the later mullite fibers and additionally one or more water-soluble polymers for temporarily stabilising the green fibers and optionally a stabiliser for stabilising the ceramic-forming ZrO₂ precursor in the spinning solution. Due to the calcination performed in step (iv), inorganic and organic constituents, such as in particular the polymer, contained initially in the green fibers are pyrolytically removed, i.e. converted into gaseous degradation products which are no longer contained in the generated fibers.

So that the ceramic-forming ZrO₂ precursor can be stabilised, it is advantageous to add the stabiliser to the solution of the ceramic-forming ZrO₂ precursor or to mix a stabiliser solution with a solution of the ceramic-forming ZrO₂ precursor.

The step (ii) is optional, i.e. if for example the spinning solution produced in step (i) already has the zero-shear-rate viscosity stated in (ii), this step can be omitted. The objective of step (ii) is to set a viscosity suitable for dry spinning. The zero-shear-rate viscosity is determined in the context of the invention described here at 25° C. with plate-plate geometry with plate diameter 25 mm and gap distance 0.5 mm. For this purpose, a Physica MCR 301 rheometer by Anton Paar can be used.

The step (i) of the above-described process can be performed as a one-pot process, wherein a spinning solution can be produced from the stated constituents by mixing the constituents with water. In particular if a stabiliser for ZrO₂ is to be incorporated into the spinning solution, it is expedient to produce a preliminary solution of the stabiliser and the ceramic-forming ZrO₂ precursor and to then mix this with the other constituents of the spinning solution.

Generally, it is expedient to firstly produce a mixture of the inorganic constituents of the later spinning solution and, as applicable, the optional stabiliser and to add to this the water-soluble organic polymer or an aqueous solution thereof. In a very particularly preferred embodiment, the spinning solution is produced in step (i) by means of the sub-steps:
(ia) transforming a ceramic-forming SiO₂ precursor and also a ceramic-forming Al₂O₃ precursor with addition of water into an aqueous mullite precursor solution and transforming a ceramic-forming ZrO₂ precursor with addition of water and also optionally a stabiliser into an aqueous ZrO₂ precursor solution,
(ib) combining the aqueous mullite precursor solution produced in accordance with step (ia) and also the ZrO₂ precursor solution produced in accordance with step (ia) to form a ZrO₂-mullite precursor solution,
(ic) adding a water-soluble organic polymer to the ZrO₂-mullite precursor solution formed in step (ib), thus forming an aqueous spinning solution.

To assist the crystallisation, mullite crystallisation seeds, for example in the form of an aqueous suspension, can be added to the solution produced in step (i) or in one of steps (ia) to (ic) of the process.

The ceramic-forming ZrO₂ precursor is not subject to any relevant limitations within the scope of the present invention, under the provision that it should be able to be converted, where possible without residue, into ZrO₂ within the scope of the processing during the process. The ceramic-forming ZrO₂ precursor therefore should not contain any constituents that cannot be reacted to form gaseous products within the scope of the processing (under oxidative conditions). For example, halides can be reacted to form gaseous products by means of the conversion into halogen hydrogens.

The ceramic-forming ZrO₂ precursor is preferably a zirconium compound of formula Zr(O)ₒX₍₄₋₂ₒ₎, wherein o=0-2 and X is a halide ion, an organic anion, preferably alcoholate, or NO₃⁻, and wherein the zirconium compound when o=2 is present as zirconium oxide sol. Particularly suitable halide ions are Br and of which Cl⁻ is very particularly preferred.

A particularly preferred ceramic-forming ZrO₂ precursor is, for example zirconium dichloride oxide (ZrOCl₂) and in particular the octahydrate of zirconium dichloride oxide.

As stated above, proportions of approximately 2 to 15 wt. % of ZrO₂, in particular of approximately 3 to 10 wt. %, and particularly preferably of approximately 3.5 to 10 wt. % are suitable for the ZrO₂-reinforced mullite fibers according to the invention. Correspondingly, it is preferred for the process described here if the ZrO₂-mullite precursor solution contains ceramic-forming ZrO₂ precursor in an amount that corresponds to approximately 2 to 15 wt. %, in particular approximately 3 to 10 wt. %, and particularly preferably approximately 3.5 to 10 wt. %, in relation to the total amount of phases of ZrO₂, Al₂O₃ and mullite to be formed from the precursor solution. On account of the different counterions or water of crystallisation contained in the ceramic-forming ZrO₂ precursors, the amount of the precursor can therefore vary within certain ranges for the manufacture of ZrO₂-reinforced mullite fibers. A person skilled in the art, however, after having settled on a certain ZrO₂ precursor, is not readily able to adjust this amount such that the desired ZrO₂ content is present in the ceramic fibers.

The water-soluble Al₂O₃ precursor is also subject in the context of the invention initially only to the limitation of a capability of conversion, where possible without residue, into Al₂O₃ (during the calcination), from which mullite can form in the reaction with SiO₂ during the sintering. Here, however, particularly suitable water-soluble Al₂O₃ precursors can include aluminium salts of formula Alₙ(OH)ₘX₍₃ₙ₋ₘ₎, wherein X is a halide ion, NO₃⁻ or an organic anion, for example an alcoholate, and wherein n=1 or 2 and m=0-5. A particularly preferred ion X is a halide ion and in particular Cl⁻. A particularly preferred water-soluble Al₂O₃ precursor is Al₂(OH)₅Cl, in particular with 2.5 units of H₂O.

A mullite proportion which is as high as possible is preferred for the ZrO₂-reinforced mullite fibers according to the invention. Correspondingly, it is preferred if the mullite precursor solution in the above-described process contains water-soluble Al₂O₃ precursor in an amount that corresponds to approximately 71 to 80 wt. %, preferably approximately 73 to 78 wt. %, and in particular approximately 75 to 78 wt. %, in relation to the total amount of theoretical Al₂O₃ and SiO₂ proportions in the mullite phase that are to be generated from the precursor solution. The term “theoretical” takes account here of the fact that Al₂O₃ and SiO₂ are contained in the mullite fibers as mullite and not “Al₂O₃” and “SiO₂” as such.

The water-soluble SiO₂ precursor is subject in principle to the same limitations as the Al₂O₃ precursor. Particularly suitable water-soluble SiO₂ precursors are colloidal silicon dioxide or a water-soluble or dispersible Si-containing organic compound, such as a silane, amino silane or ortho silicic acid ester.

For the manufacture of fibers with high mullite proportion, it is preferred if the mullite precursor solution contains water-soluble SiO₂ precursor in an amount that corresponds to approximately 20 to 28 wt. %, in particular approximately 22 to 27 wt. %, and particularly preferably approximately 23 to 25 wt. %, in relation to the total amount of theoretical Al₂O₃ and SiO₂ proportions in the mullite phase that are to be formed from the precursor solution. With regard to the term “theoretical”, the same is true as has been explained for the corresponding Al₂O₃ proportion.

The water-soluble organic polymer serves in the process described here above all as a temporary binder for the inorganic components in the initially generated green fibers and as the viscosity-increasing means for the spinning. Since the polymer is no longer contained in the ceramic fibers, the structure of the polymer per se is not essential for the process. For example, poly(vinylpyrrolidone), poly(vinyl alcohol) and/or poly(ethylene oxide) can be used as particularly suitable water-soluble organic polymers, with poly(vinylpyrrolidone) being particularly suitable. A formation of gel, which is undesirable for the spinning, is additionally avoided by means of the polymer.

The amount of the water-soluble organic polymer to be incorporated in the spinning solution is preferably to be selected such that the desired viscosity is achieved and a sufficient stabilisation of the green fibers until the further processing is ensured. An excessively high proportion is therefore to be avoided for cost reasons and because, with greater polymer proportions, there is a greater shrinkage of the fibers during the calcination. A weight ratio of polymer to total oxide content in the spinning solution from 20:80 to 40:60 and in particular 25:75 to 30:70 can be specified as being favourable.

An advantageous control of the viscosity and stabilisation of the green fibers can be attained by a suitable selection of the molecular weight of the water-soluble polymer. It is particularly expedient here if a polymer with a molecular weight M_{W} of less than 200,000 g/mol and preferably in the range from approximately 20,000 to 70,000 g/mol is used. The use of a mixture of water-soluble polymers with different molecular weight is particularly advantageous, wherein a first polymer with a molecular weight M_{W} of less than 200,000 g/mol, in particular in the range from approximately 20,000 to 70,000 g/mol, and a second polymer with a molecular weight M_{W} of more than 1,000,000 g/mol is used. A particularly preferred second polymer has a molecular weight M_{W} in the range from 1,100,000 to 1,500,000 g/mol. A particularly preferred material for the first and optionally the second polymer is poly(vinylpyrrolidone). The various molecular weights are to be determined here by means of GPC with use of suitable standards (for example poly(styrene)).

The stabiliser for the ZrO₂ precursor which is preferably used in the spinning solution, and in the aqueous ZrO₂ precursor solution is expediently a carboxylic acid which is preferably selected from the group comprising glycine, serine, cysteine, oxalic acid, malonic acid, glutaric acid, adipic acid, acetic acid, glycolic acid, lactic acid, tartaric acid, and/or citric acid. Very particularly preferred stabilisers are glycine and serine.

The calcination in step (iv) of the above-described process is performed at a temperature at which the respective precursors of ZrO₂, Al₂O₃ and SiO₂ are converted into the respective oxides, but at which the mullite to be generated in the end effect has not yet formed. In addition, volatile constituents (i.e. in particular polymer and any stabiliser present) are removed pyrolytically within the scope of the calcination. For the conversions, advantageous temperatures which are therefore preferred for step (iv) lie in the range from approximately 700 to 1000° C. and in particular approximately 850 to 900° C.

Since the calcination and most complete pyrolytic removal possible of the volatile constituents generally takes some time, 240 to 600 min and in particular 300 to 400 min are specified as a suitable time period for this step. A continuous furnace can be used expediently for the calcination.

The sintering and the conversion, induced therein, of the inorganic precursor fibers into the mullite fibers take place in a tube furnace at higher temperatures as compared to the calcination, preferably at a temperature in the range from approximately 1200 to 1600° C., and in particular approximately 1300 to 1500° C. Since this conversion generally proceeds very quickly, it is usually sufficient if the inorganic precursor fibers are exposed to these conditions preferably for a time period from 60 to 400 sec and in particular from 180 to 300 sec.

In the tests forming the basis of the invention described here, it was found that the ZrO₂-reinforced mullite fibers manufactured by means of the above-described process are distinguished by a favourably uniform distribution of the ZrO₂ phase in the fibers, which was also observed at higher proportions of ZrO₂ (in particular 3 wt. % or more). At the same time, these ZrO₂-reinforced mullite fibers had advantageous mechanical properties, such as in particular high breaking load and breaking elongation values. It is obvious that both observations are related. Correspondingly, a further aspect of the invention described herein relates to ZrO₂-reinforced mullite fibers that can be manufactured or have been manufactured in accordance with the above-described process.

In addition, the above-described process provides the advantage that the mullite is formed only at higher temperatures of >1200° C. (compared to manufacture from a molecular disperse precursor system). This means that the material compresses to a greater extent before the creep-resistant mullite forms. With a formation of mullite already at lower temperatures (for example approximately 1000° C.), the mullite forms earlier by contrast and then counteracts a compaction of the material, which usually results in the formation of pores and accompanying unfavourable mechanical properties.

According to a further aspect, the present invention relates to ceramic-forming green fibers in the form of filaments, as are obtainable or have been obtained in accordance with process steps (i) to (iii) of the above-described process. The wording “ceramic-forming” denotes here the suitability of the green fibers for a later conversion into ceramic fibers.

In yet a further aspect, the present invention relates to the use of the above-described ZrO₂-reinforced mullite fibers in fibre-matrix composite materials, i.e. in materials in which the fibers are incorporated in a surrounding matrix material. In particular, polymer, metal or ceramic materials are potential matrix materials here, with metal and ceramic materials being preferred on account of their high temperature resistance. By way of the ZrO₂-reinforced mullite fibers according to the invention, the fibre-matrix composite materials can be provided in particular with an improved strength, rigidity and/or high-temperature stability. The use generally includes an infiltration of the ZrO₂-reinforced mullite fibers or the textile fabrics produced therefrom with liquid or liquefied matrix material or a precursor thereof and the solidification of the mixture.

The present invention will be explained in greater detail hereinafter on the basis of examples, although these are merely intended for illustrative purposes and are not to be interpreted as limiting for the scope of protection of the application.

### EXAMPLES

The mechanical properties of the fibers manufactured in the following examples were determined as follows:

Tensile strength and elastic modulus of the fibers were determined using a Favimat from the company Textechno. For this purpose, individual filaments with a clamping length of 25 mm were clamped between two draw-off clamps and their resonance frequency after reaching the preload of 0.25 cN/tex was measured. For this purpose, the vibration process integrated in the testing device was used, said process calculating the linear density of the fibers with the aid of the resonance frequency and then using this to ascertain the fibre diameter. The individual filaments were loaded at a testing speed of 1 mm/min. The software belonging to the measuring device was used to evaluate the tensile tests. At least 30 valid measurements were used for the evaluation. The tensile strengths were determined from the arithmetic mean of the individual tensile strengths, and the Weibull strengths and the Weibull modulus were calculated.

Flexural tests were performed on sized fibre bundles comprising 468 filaments on a Zwick/Roell universal testing machine (Z010). The software testXpert®II was used for the evaluation. The fibre bundles were bent by way of a fixed deflection with defined diameters of 2.0, 2.25 and 2.5 mm and fastened to a holder. The clamping length was 10 cm, the preliminary force 40 cN. The fibre bundles were stretched with a testing speed of 5 mm/min and the maximum breaking load and breaking elongation until breakage were measured at the deflection. The mean values of the breaking loads and breaking elongations were formed in each case from at least 15 measurements.

### Example 1: Fibre Manufacture by Means of Winding Tests

Production of the Spinning Solution:

Locron L® as 50 wt. % solution of Al₂(OH)₅Cl·2,5 H₂O in water as Al₂O₃ precursor and Levasil® as 30 wt. % solution of SiO₂ particles as SiO₂ precursor were placed in a glass beaker. Furthermore, in relation to the amount of Locron L®, 6 wt. % of a 5 wt. % aqueous mullite seed suspension were added. Different amounts of zirconium dichloride oxide octahydrate ZrOCl₂·8 H₂O were dissolved, with stirring, in demineralised water in a second glass beaker, and optionally up to 1 equivalent of the stabiliser, in relation to the amount of zirconium dichloride oxide octahydrate, was added. The solution continued to be stirred for a few minutes in order to ensure that the stabiliser dissolved fully. The precursor solutions were combined. Low-molecular PVP K30 (Sigma Aldrich) was added in a ratio of 95:5 wt. % with high-molecular PVP (Sigma Aldrich, M_{w}˜1,300,000) with stirring. The spinning solutions continued to be stirred using a KPG stirrer at room temperature until a homogeneous spinning solution was obtained.

For the manufacture of the fibers, the amounts of the precursors for Al₂O₃ and SiO₂ were set such that, during the processing, an Al₂O₃/SiO₂ molar ratio of 3:2 was established. The weight ratio of oxide to polymer in the spinning masses was 70:30.

Production of the Spinning Mass:

The obtained spinning solution was concentrated at reduced pressure and under slow rotation on the rotary evaporator until a spinning mass that is viscous at room temperature (zero-shear-rate viscosity η₀ of 222 Pas at 25° C., determined using a Physica MCR 301 rheometer from Anton Paar with plate-plate geometry with plate diameter 25 mm and gap distance 0.5 mm) was obtained.

The spinning masses thus produced were tested in winding tests. For this purpose, a few grams of the spinning mass were placed on a watch glass. A thread drawn vertically upwardly therefrom was placed on a spool which was driven by means of a winder. The distance between the spinning mass and the core of the spool was 82 cm. The maximum possible winding speed and also the time until the thread breaks was then determined.

The results of these determinations and also the ZrO₂ proportion of the various spinning masses are reproduced in the following Table 1:

TABLE 1

| Proportion of | Equivalent | η₀ | Total oxide | Max. winding |
|---|---|---|---|---|
| ZrO₂ [wt. %] | stabiliser | [Pa · s] | content [wt. %] | speed [m/min] |
| 1.0 | — | 223 | 31.8 | 22 |
| 3.0 | — | 202 | 31.3 | 22 |
| 3.0 | 0.3¹ | 202 | 31.1 | 22 |
| 5.0 | — | 200 | 32.2 | 16 |
| 7.0 | 0.5² | 246 | 32.6 | 22 |
| 15.0 | 1.0¹ | 239 | 36.3 | 22-27.5 |

¹= glycine,
²= citric acid

It can be seen from Table 1 that satisfactory winding speeds can be achieved with various ZrO₂ proportions. With an addition of glycine, yet further improved winding speeds can be realised, in particular with very high ZrO₂ precursor contents and even in comparison to lower contents.

### Example 2

Production of the Spinning Solution and Spinning Mass:

Similarly to Example 1, a spinning mass was produced with an amount of the precursors for Al₂O₃ and SiO₂ set such that, during the processing, an Al₂O₃/SiO₂ molar ratio of 3:2 was established. The weight ratio of oxide to polymer in the spinning masses was 70:30, the proportion of ZrO₂, in relation to the Al and Si oxides, was 3 wt. %. The ratio of low-molecular PVP K30 to high-molecular PVP was 95:5 wt. %. The spinning mass was set to a zero-shear-rate viscosity of 222 Pas at 25° C., determined using a Physica MCR 301 rheometer from Anton Paar with plate-plate geometry with plate diameter 25 mm and gap distance 0.5 mm.

Production of the Green Fibers:

The spinning masses were extruded under pressure using a spinning pump with a delivery rate of 2.4 cm³/r over a 468-hole nozzle plate. The diameters of the nozzle holes were each 100 μm, the channel lengths 200 μm. The filament bundles were removed vertically downwards by a heated spinning shaft. The fibers were then received at a speed of up to 160 m/min. Before receiving the endless filaments, a spinning preparation was applied in order to achieve a thread cohesion of the individual filaments. The green fibers obtained were stored at defined temperature and relative air humidity (22° C., 36-38% r.h.).

The green fibers produced had a water content in the range from 16 to 18 wt. %. The water content was determined by means of a Karl-Fischer titration by evaporation at 140° C.

Production of the Ceramic Fibers:

The green fibers produced were initially calcined continuously in a continuous furnace at temperatures in the range of 700-1000° C. for a time period of 320 min. The calcined fibers were then transformed into ceramic fibers in a 4 m long tube furnace at temperatures in the range of 1200-1600° C. at a throughput speed of 2.5 m/min or 2 m/min. The residence time of the fibers in the sintering furnace was approximately 1.6 min.

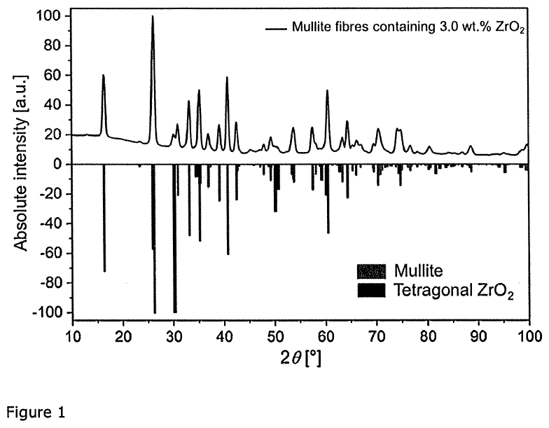

An x-ray diffractogram of the fibers thus obtained is shown in FIG. 1. All detected reflections were able to be assigned with the aid of literature diffractograms. Mullite can be identified as main phase on the basis of the characteristic reflections of high intensity at 28=16.4, 25.9, 26.2, 40.8 and 60.5°. The reflection characteristic for the tetragonal modification of ZrO₂ at 28=30.2°, which is absent in the case of monoclinic and cubic ZrO₂, was also detected.

The various Weibull strengths σ₀, the relative Weibull strengths σ_{0,rel 0} the Weibull moduli (m) and the elastic moduli were determined for the fibers thus obtained. The results of these tests are reproduced in the following Table 2. For comparison, the corresponding values of pure mullite fibers (i.e. without ZrO₂) are stated:

TABLE 2

| | | | | |
|---|---|---|---|---|
| | | | | Elastic |
| | | | | modulus |
| T [° C.] | σ₀ [MPa] | σ_{0,rel} [%] | m | [GPa] |

Throughput speed 2.5 m/min

| | | | | |
|---|---|---|---|---|
| RT | 1359 | 100 | 11.8 | 200 |
| 1000 | 1340 | 99 | 5.6 | 196 |
| 1200 | 1316 | 97 | 6.1 | 209 |
| 1300 | 1225 | 90 | 5.8 | 217 |

Throughput speed 2.0 m/min

| | | | | |
|---|---|---|---|---|
| RT | 1378 | 100 | 7.2 | 202 |
| 1000 | 1394 | 101 | 6.1 | 203 |
| 1200 | 1254 | 91 | 5.8 | 194 |
| 1300 | 1361 | 99 | 6.3 | 212 |

Pure mullite fibers (comparison), throughput speed 2.5 m/min

| | | | | |
|---|---|---|---|---|
| RT | 1323 | 100 | 9.5 | 191 |
| 1000 | 1320 | 100 | 6.5 | 204 |
| 1200 | 1276 | 96 | 8.0 | 212 |
| 1300 | 1232 | 93 | 6.7 | 197 |

The comparison of the various fibers shows equivalent to slightly improved mechanical properties for the ZrO₂-containing fibers.

The results of the flexural tests are reproduced in the following Table 3:

TABLE 3

| | Breaking load [N] | | Breaking elongation [%] | |
|---|---|---|---|---|
| | | Mullite | | Mullite |
| Deflection | Pure mullite | fibers with | Pure mullite | fibers with |
| diameter | fibers | 3.0 | fibers | 3.0 |
| [mm] | (comparison) | wt. % ZrO₂ | (comparison) | wt. % ZrO₂ |
| 2.0 | 6.3 ± 1.2 | 10.9 ± 1.5 | 0.7 ± 0.2 | 1.2 ± 0.2 |
| 2.25 | 8.4 ± 1.4 | 12.2 ± 2.3 | 0.8 ± 0.2 | 1.3 ± 0.4 |
| 2.5 | 11.6 ± 2.1 | 16.9 ± 1.8 | 1.3 ± 0.4 | 2.0 ± 0.3 |

As can be seen from Table 3, the ZrO₂-reinforced mullite fibers are distinguished by significantly improved mechanical properties (breaking loads and breaking elongations) compared to the fibers without ZrO₂. They have a positive effect, amongst other things, on the textile processability of the fibers. The increased breaking loads and breaking elongations result in a considerably increased breaking work.

1. ZrO₂-reinforced mullite fibers, characterised in that they contain at least 0.1 wt. % of crystalline ZrO₂, wherein the ZrO₂-reinforced mullite fibers contain at least 80 wt. % of crystalline mullite.

2. ZrO₂-reinforced mullite fibers according to claim 1, characterised in that the fibers have a diameter in the range of >5 μm and in particular in the range of 7 to 13 μm.

3. ZrO₂-reinforced mullite fibers according to claim 1, characterised in that they contain 3 to 15 wt. %, and preferably from 3 to 10 wt. % of crystalline ZrO₂, very particularly preferably in tetragonal modification.

4. ZrO₂-reinforced mullite fibers according to claim 1, characterised in that they contain at least 85 wt. %, and particularly preferably 90 to 97.5 wt. % of crystalline mullite.

5. ZrO₂-reinforced mullite fibers according to claim 1, characterised in that the crystalline ZrO₂ has grain sizes in the range from 10 to 60 nm, in particular from 20 to 35 nm.

6. ZrO₂-reinforced mullite fibers according to claim 1, characterised in that they contain, in relation to the total amount of Al₂O₃ and SiO₂, 71 to 80 wt. %, in particular 73 to 78 wt. %, and particularly preferably 75 to 78 wt. % of theoretical Al₂O₃ proportion in the mullite phase.

7. ZrO₂-reinforced mullite fibers according to claim 1, characterised in that the residual phase contains Al₂O₃ or consists thereof.

8. ZrO₂-reinforced mullite fibers according to claim 1, characterised in that they have a breaking load of at least 12.0 N, preferably of at least 14.0 N, and in particular of at least 15.0 N and/or a breaking elongation of at least 1.5%, in particular of at least 1.6%, and particularly preferably of 2.0±0.3%, determined in each case on a fibre bundle of 468 filaments with a thickness of 10 μm at a testing speed of 5 mm/min at a fixed deflection with a diameter of 2.5 mm.

9. A process for manufacturing ZrO₂-reinforced mullite fibers, in particular according to claim 1, characterised in that
(i) a spinning solution is prepared from a ceramic-forming SiO₂ precursor, a ceramic-forming Al₂O₃ precursor, a water-soluble organic polymer, a ceramic-forming ZrO₂ precursor and optionally a stabiliser, wherein with use of a stabiliser this is used in particular as solution with the ceramic-forming ZrO₂ precursor,
(ii) the water of the spinning solution, if necessary, is partially evaporated in order to produce a spinning mass with a zero-shear-rate viscosity of at least 150 Pa·s, in particular in the range of 180 to 350 Pas (determined in each case at 25° C.).
(iii) the spinning mass is subjected to a dry spinning process, thus resulting in green fibers,
(iv) the green fibers are calcined, thus forming inorganic precursor fibers, wherein volatile constituents are removed pyrolytically, and
(v) the inorganic precursor fibers are sintered, with mullite-phase formation, to give ZrO₂-reinforced mullite fibers.

10. The process according to claim 9, characterised in that the water-soluble ZrO₂ precursor is a zirconium compound of formula Zr(O)ₒX₍₄₋₂ₒ₎, wherein o=0-2 and X is a halide ion, an organic anion, preferably alcoholate, or NO₃⁻, and wherein the zirconium compound when o=2 is present as zirconium oxide sol.

11. The process according to claim 9 or 10, characterised in that the ZrO₂-mullite precursor solution contains water-soluble ZrO₂ precursor in an amount that corresponds to 2 to 15 wt. % and in particular 3 to 10 wt. % of ZrO₂, in relation to the total amount of phases of ZrO₂, Al₂O₃ and mullite to be formed from the precursor solution.

12. The process according to claim 9, characterised in that the water-soluble Al₂O₃ precursor is an aluminium salt of formula Alₙ(OH)ₘX₍₃ₙ₋ₘ₎, wherein X is a halide ion, NO₃⁻ or an organic anion, preferably Cl⁻, and wherein n=1 or 2 and m=0-5.

13. The process according to claim 9, characterised in that the mullite precursor solution contains water-soluble Al₂O₃ precursor in an amount that corresponds to 71 to 80 wt. %, in particular approximately 73 to 78 wt. %, and particularly preferably 75 to 78 wt. %, in relation to the total amount of theoretical Al₂O₃ and SiO₂ proportions in the mullite phase.

14. The process according to claim 9, characterised in that the water-soluble SiO₂ precursor is colloidal silicon dioxide or a water-soluble or dispersible Si-containing organic compound.

15. The process according to claim 9, characterised in that the mullite precursor solution contains water-soluble SiO₂ precursor in an amount that corresponds to 20 to 28 wt. %, in particular 22 to 27 wt. %, and particularly preferably 23 to 25 wt. %, in relation to the total amount of theoretical Al₂O₃ and SiO₂ proportions in the mullite phase that are to be formed from the precursor solution.

16. The process according to claim 9, characterised in that poly(vinylpyrrolidone), poly(vinyl alcohol), poly(ethylene oxide), in particular poly(vinylpyrrolidone), is used as water-soluble organic polymer.

17. The process according to claim 9, characterised in that the aqueous spinning solution contains water-soluble organic polymer in a weight ratio of polymer to the total oxide content of 20:80 to 40:60 and in particular 25:75 to 30:70.

18. The process according to claim 9, characterised in that the water-soluble organic polymer comprises a first polymer having a molecular weight Mw of less than 200,000 g/mol and also optionally a second polymer having a molecular weight Mw of more than 1,000,000 g/mol, in particular in a ratio in the range of 100:0 to 90:10.

19. The process according to claim 9, characterised in that the aqueous ZrO₂ precursor solution contains as stabiliser a carboxylic acid, in particular selected from glycine, serine, cysteine, oxalic acid, malonic acid, glutaric acid, adipic acid, acetic acid, glycolic acid, lactic acid, tartaric acid, and citric acid, particularly preferably in the form of glycine or serine.

20. The process according to claim 9, characterised in that the green fibers are calcined at a temperature of 700 to 1000° C. and preferably 850 to 900° C. with pyrolytic removal of volatile constituents, in particular for a period of 240 to 600 min and particularly preferably of 300 to 400 min.

21. The process according to claim 9, characterised in that the inorganic precursor fibers are sintered at a temperature of 1200 to 1600° C. and preferably 1300 to 1500° C., thus obtaining ZrO₂-reinforced mullite fibers, in particular for a period of 60 to 400 sec and particularly preferably of 180 to 300 sec.

22. ZrO₂-reinforced mullite fibers manufacturable by a process according to claim 9.

23. Ceramic-forming green fibers in the form of filaments, obtainable by process steps (i) to (iii) according to claim 9.

24. (canceled)
